(19) United States
(12) Patent Application Publication
(10) Pub. No.: US 2012/0278208 A1
(43) Pub. Date: Nov. 1, 2012

(54) Transporting Currency

(75) Inventor: Robert A. Walters, Northville, MI (US)

(73) Assignee: Burroughs Payment Systems, Inc., Plymouth, MI (US)

(21) Appl. No.: 13/096,008

(22) Filed: Apr. 28, 2011

(51) Int. Cl. G06Q 40/00; G06Q 30/00

(52) U.S. Cl. 705/30; 235/385

(57) ABSTRACT

A method of handling currency includes receiving currency into a safe at a first location. The safe is configured to count and store currency. The method further includes receiving a withdrawal request for an amount of currency stored in the safe. In response to the withdrawal request, the safe deposits the requested amount of currency into a container, associates information with the container, seals the container, and after sealing the container, allows retrieval of the container (e.g., from the safe). The method includes retrieving the sealed container, transporting the sealed container to a second location, and receiving the sealed container in a secure deposit system at the second location.

### TECHNICAL FIELD

This disclosure relates to transporting currency in a tamper-evident manner.

### BACKGROUND

Merchants or commercial personnel generally deposit business cash at a financial institution by either 1) contracting an armored service to pick up the cash from a retail or commercial location and transport the cash to the financial institution or 2) the personnel personally transports the cash from the retail or commercial location to the financial institution. Both of these methods provide opportunities for theft, miscounting, and mishandling of the cash.

### SUMMARY

One aspect of the disclosure provides a method of handling currency. The method includes receiving currency into a safe at a first location. The safe is configured to count and store currency. The method further includes receiving a withdrawal request for an amount of currency stored in the safe. In response to the withdrawal request, the safe deposits the requested amount of currency into a container, associates information with the container, seals the container, and after sealing the container, allows retrieval of the container (e.g., from the safe). The method includes retrieving the sealed container, transporting the sealed container to a second location, and receiving the sealed container in a secure deposit system at a second location.

Implementations of the disclosure may include one or more of the following features. In some implementations, the method includes communicating (e.g., electronically over a communication network) at least some of the information associated with the container to at least one of a computing device and a storage device of the second location. The method may include communicating the information to a cloud computing device, to which the second location may have access. In some examples, the information includes at least one of an origination location identifier, a destination location identifier, a currency amount, a date stamp, a time stamp, an operator identifier, a transporter identifier, a container identifier, and a merchant identifier. The method may include reading the information associated with the container upon receiving the container in the secure deposit system at the second location.

In some implementations, the method includes storing the information on an information storage device, which may include at least one of a barcode and a radio frequency identification device. The information storage device can be attached to the container. Moreover, upon receiving the container in the secure deposit system at the second location, the method may include reading the information storage device. For example, the secure deposit system may include a deposit receiver having a container reader operable to read the information storage device.

The container may be a tamper evident container, such as a sealed cassette or tamper evident bag. The method may include depositing the requested amount of currency into the container inside the safe and/or causing the safe to provide a count of the currency deposited in the container. A chain of custody of the container may be tracked while in transport between the first location and the second location.

Another aspect of the disclosure provides a currency handling system that includes a safe at a first location. The safe receives currency and counts and stores the currency. Upon receiving a withdrawal request for an amount of currency stored in the safe, the safe deposits the requested amount of currency into a tamper evident container, associates information with the container, seals the container, and after sealing the container, allows retrieval of the container. The system also includes a secure deposit system at a second location, which is configured to receive the sealed container.

In some implementations, the currency handling system includes a communicator communicating at least some of the information associated with the container to at least one of a computing device and a storage device of the second location. The communicator may communicate the information electronically over a communication network, such as to a cloud computing device and/or the computing device or the storage device of the second location. In some examples, the communicator is or is part of a controller of the safe. The safe controller may communicate at least some of the information associated with the container to at least one of a computing device and a storage device of the second location upon allowing retrieval of the container. The information may include at least one of an origination location identifier, a destination location identifier, a currency amount, a date stamp, a time stamp, an operator identifier, a transporter identifier, a container identifier, and a merchant identifier.

The secure deposit system may read the information associated with the container. For example, the safe may store the information on an information storage device, which may include at least one of a barcode and a radio frequency identification device. The information storage device can be attached to the container, for example, by the safe. In some examples, the secure deposit system includes a container reader operable to read the information storage device, such that when (or after) the secure deposit system receives container, the container reader reads the information storage device. So as to maintain secure transportation of the currency, the information storage device can maintain a chain of custody log of the container while in transport between the first location and the second location.

The safe may deposit the requested amount of currency into the container while housed securely inside the safe. This eliminates human error (e.g., mishandling or theft) while filling the container. Moreover, the container may be a tamper evident bag having multiple layers of polyethylene film for secure transport of the currency.

In yet another aspect, a currency handling system includes a means at a first location for receiving currency, counting and storing the currency, and upon receiving a withdrawal request for an amount of stored currency, depositing the requested amount of currency into a means for transporting the currency in a tamper evident manner, associating information with the means for transporting the currency, sealing the means for transporting the currency, and after sealing the means for transporting the currency, allowing retrieval of the means for transporting the currency. The currency handling system also includes a means at a second location for receiving the sealed means for transporting the currency.

In some implementations, the currency handling system includes a means for communicating at least some of the information associated with the means for transporting the currency to at least one of a computing device and a storage device of the second location. The means for communicating may communicate the information electronically over a communication network and/or to a cloud computing device. The information may include at least one of an origination location identifier, a destination location identifier, a currency amount, a date stamp, a time stamp, an operator identifier, a transporter identifier, a container identifier, and a merchant identifier. In some examples, the currency handling system includes a means for reading the information associated with the container after receipt at the second location. Moreover, the currency handling system may include a means for maintaining a chain of custody log of the means for transporting the currency while in transport between the first location and the second location.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a schematic view of a system for transporting currency.

FIG. 2 is an exemplary arrangement of operations for handling currency.

FIGS. 3A and 3B are perspective views of an exemplary safe.

FIG. 4A is perspective view of an exemplary cassette.

FIG. 4B is front view of an exemplary tamper evident bag.

Like reference symbols in the various drawings indicate like elements.

### DETAILED DESCRIPTION

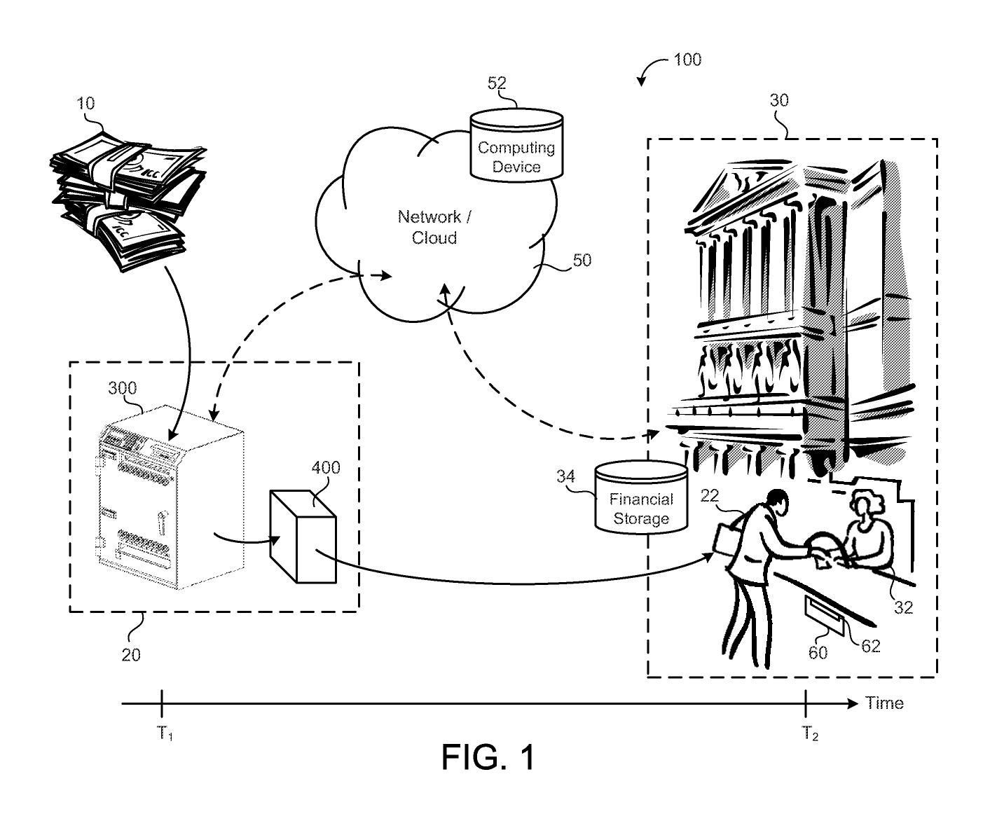

Referring to FIG. 1, in some implementations, a system 100 of transporting currency 10, such as between a first location 20 (e.g., a commercial location) and a second location 30 (e.g., a financial institution), includes a safe 300 at the first location 20 for receiving deposits of currency 10 (i.e., money) and a tamper evident container 400 for transporting the currency 10 to the second location 30. The safe 300 maintains a count of all of the currency 10 held by the safe and dispenses the currency 10 (e.g., all or a portion of the currency 10 held by the safe 300) into the tamper evident container 400 before ejecting or allowing retrieval of the container 400 from the safe 300 for transportation to the second location 30. Since the currency 10 remains inside the container 400 from a first time T₁ inside the safe 300 to a second time T₂ inside the financial institution, the system 100 provides end-to-end tamper evidence of the transported currency 10, thus reducing the risk of the currency being mishandled, stolen, or miscounted. In other words, the system 100 provides evidence of tampering while the currency 10 is transported from a secure first location 20 (e.g., the safe 300 at a business location) to a secure second location 30 (e.g., in the hands of a representative at a financial institution). By implementing end-to-end tamper evidence for currency transportation, individuals and businesses can use commercially available public couriers as transporting agents of the transported currency 10.

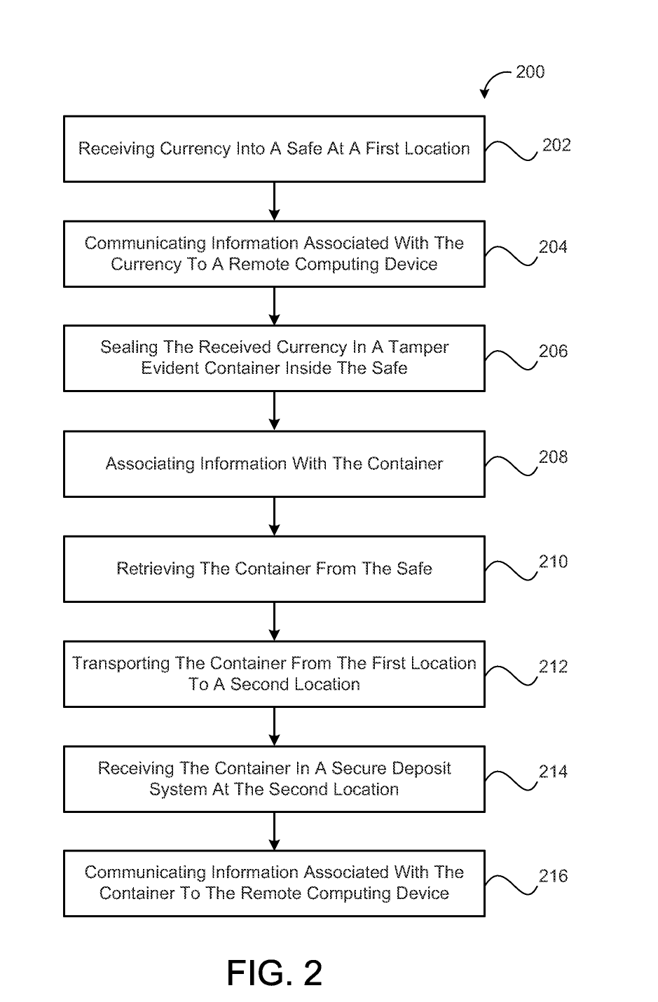

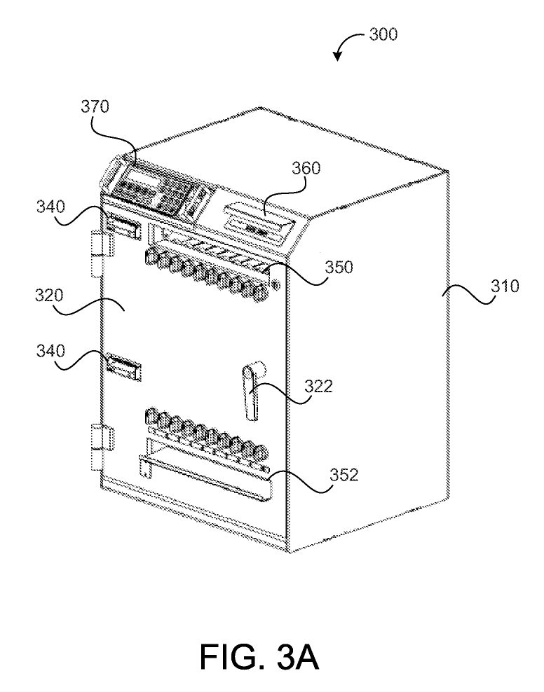

FIG. 2 provides an exemplary arrangement 200 of operations for transporting currency 10 (i.e., money). The method includes receiving 202 currency 10 into a safe 300. A user may manually deposit currency 10 into the safe 300, for example, by feeding bills into an automated currency reader 340 (FIG. 3A) that ingests and counts individual pieces of currency 10 and/or dropping the currency 10 into a deposit receiver 360 (FIG. 3A). The safe 300 may be configured to count the currency 10 (e.g., while receiving the currency 10 and/or after receiving the currency 10) and securely store the currency 10.

Referring to FIGS. 3A and 3B, in some implementations, the safe 300 includes a safe housing 310 having a door 320 pivotally attached to the safe housing 310 to move between an open position for accessing an inner chamber 330 defined by the safe housing 310 and a closed position. The door 320 includes an actuatable handle 322 for securing the door 320 in the closed position. The safe 300 may include one or more automated currency readers 340 configured to ingest and count individual pieces of currency 10. The currency readers 340 can store the received currency in a respective container 400. The container 400 can be a tamper evident container that securely holds currency 10. The safe 300 may include a coin tube loader 350 for receiving and optionally counting coins as well as a coin tube dispenser 352 for dispensing tubes of coins as part of a withdrawal from the safe 300. In some examples, the safe 300 includes a deposit receiver 360 for receiving currency deposits into the safe 300. The deposit receiver 360 may read information marked on a deposit container to determine a currency amount of the received deposit. For example, the deposit receiver 360 may include a barcode scanner or radio frequency (RF) reader that reads information from a corresponding barcode or RF tag on the deposit container. In the example shown, the safe 300 includes a control panel 370 for programming operation settings of the safe 300 (e.g., user access, time-outs, currency type, network access, etc). The control panel 370 communicates with a safe controller 375 (e.g., circuit or programmable logic circuit) that controls operation of the safe 300 and any communications with the safe 300. For example, the safe controller 375 may communicate with the currency readers 340, the coin tube loader 350, the coin tube dispenser 352, and the deposit receiver 350 to determine an amount of currency received by and/or withdrawn from the safe 300. The safe controller 375 may communicate with the actuatable handle 322 to control access to the inner chamber 330, a communication network 50, and/or a remote computing device 52, such as a cloud server, for communicating deposit/withdrawal information.

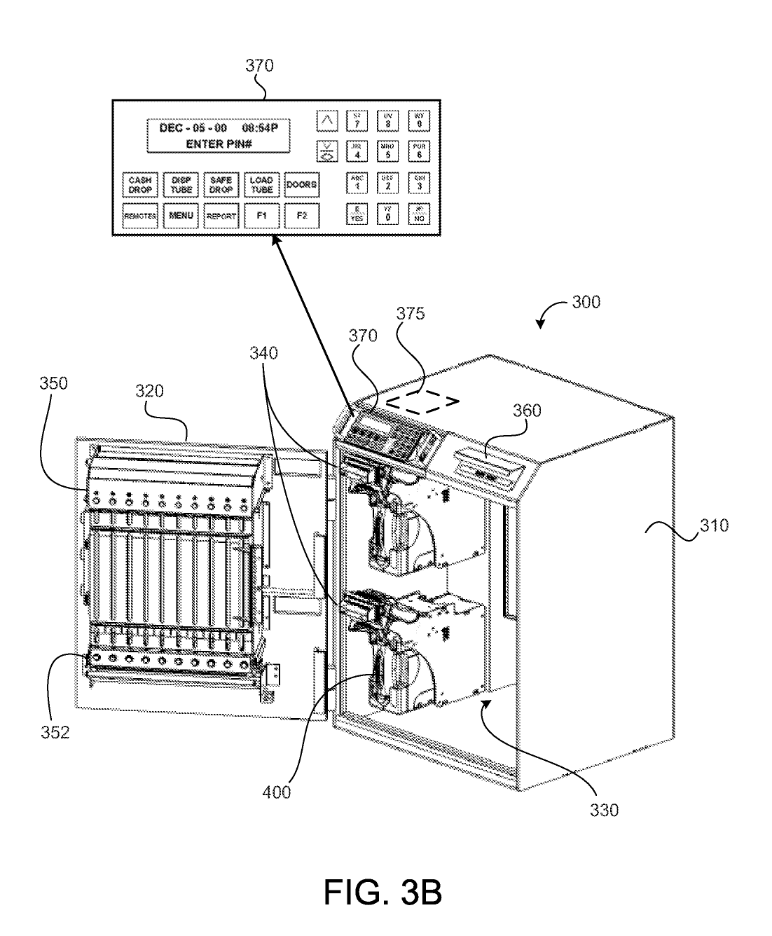

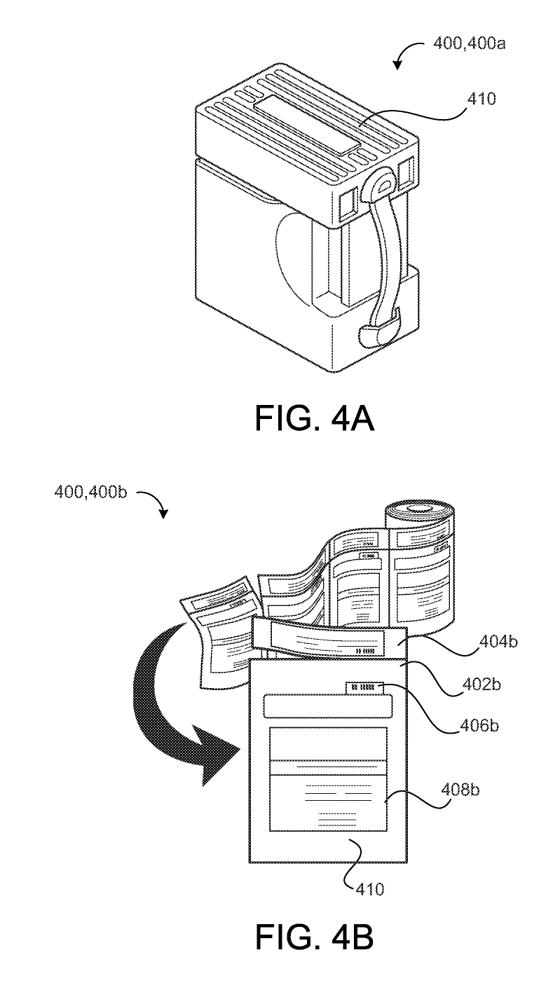

Referring again to FIGS. 2-4B, the method may include communicating 204 information associated with the currency 10 received by the safe 300 to a remote computing device 52 and sealing 206 the received currency in a tamper evident container 400 (e.g., a cassette 400a (FIG. 4A) or tamper evident bag 400b (FIG. 4B)) inside the safe 300 before allowing access to the container 400 at the first location 20.

After receiving the currency 10, the safe 300 may count and store the currency 10 in one or more containers 400, for example, by using automation. The automation may include currency readers 340 and/or other money handling equipment. The container 400 may be configured to provide evidence of tampering. In the example shown in FIG. 4A, the container 400 is a cassette 400a, which provides secure tamper-proof storage of currency 10. The cassette 400a is configured to receive currency 10 from a currency reader 340 and transport the received currency 10 without a user actually contacting or touching the stored currency 10. In the example shown in FIG. 4B, the container 400 is a tamper-evident bag 400b, which may be constructed of a relatively heavy gauge polyethylene (e.g., 3 mil or 75 micron thickness). In some examples, the bag 400b is constructed of multiple layers of polyethylene film. The bag 400b may include a tamper-evident closure 402b (e.g., high strength tape that causes physical damage or destruction of the bag 400b when opening the closure 402b), a tear-off receipt 404b, a tracking identifier 406b (e.g., a serial number), and/or a security bag seal 408b (e.g., an in-set seal that yields a relatively high strength film bond to the bag 400b).

The method may further include associating 208 information with the container 400. For example, an information storage device 410, such as a barcode (two or three dimensional) or radio frequency identification (RFID) can be applied to the container 400. The information storage device 410 contains or stores at least some of the information to be associated with the container 400. The safe 300 may apply the information storage device 300 (e.g., using automation, such as a label applicator) to the container 400. The information may include a quantity of the currency 10 held by the safe 300 at any given time, a date-timestamp and amount of each deposit into and withdrawal from the safe 300, a unique identifier for the container(s) 400 held by the safe 300, an origination location identifier, a destination location identifier, an operator identifier, a date and/or time stamp of withdrawal of the container 400, a transporter identifier, a container identifier, and a merchant identifier, etc.

In some examples, the information storage device 410 maintains a chain of custody log of the container 400 while in transport between the first location 20 and the second location 30. For multiple deposits, the information may include multiple date-timestamps, currency amounts of each deposit, and/or unique identifiers corresponding to each deposit. In some examples, the information storage device 410 or another device in communication with the information storage device 410 communicates the chain of custody to the communication network 50 and./or the remote computing device 52.

In some implementations, the safe controller 375 transmits (e.g., wirelessly or electronically, such as over an Ethernet connection) some or all of the associated information to the communication network 50 (e.g., cloud network) and/or remote computing device 52 (e.g., cloud server and/or cloud storage). In some examples, the communication network 50 provides direct communication with the second location 30 (e.g., with financial storage 34, such as a computing device, server and/or a database) or a remote receiver for data collection and management. In additional examples, the communication network 50 is a cloud that provides cloud computing and/or cloud storage capabilities. The second location 30 and/or other parties can communicate with the safe 300 through the cloud 50. Cloud computing may provide Internet-based computing, whereby shared servers provide resources, software, and data to computers and other devices on demand. For example, the cloud 50 may be a cloud computing service that includes at least one server computing device, which may include a service abstraction layer and a hypertext transfer protocol wrapper over a server virtual machine instantiated thereon. The server computing device may be configured to parse HTTP requests and send HTTP responses. Cloud computing may be a technology that uses the Internet and central remote servers to maintain data and applications. Cloud computing can allow users to access and use applications without installation and access personal files at any computer with internet access. Cloud computing allows for relatively more efficient computing by centralizing storage, memory, processing and bandwidth. The cloud 50 can provide scalable, on-demand computing power, storage, and bandwidth. Safe connectivity to the cloud 50 allows automatic data gathering of safe operation and usage histories without requiring a user of the safe 300 to enter and upload data. Moreover, continuous data collection over time can yield a wealth of data that can be mined for marketing, product development, and support.

The remote computing device 52 may be cloud storage, which can be a model of networked computer data storage where data is stored on multiple virtual servers, generally hosted by third parties. By providing communication between the safe 300 and the cloud network 50, information gathered by the safe 300 can be securely viewed by authorized users via a web based information portal.

The method may include retrieving 210 the container 400 from the safe 300. In some implementations, the safe 300 ejects the container 400 upon receiving a command from a user (e.g., by pressing a safe drop on the safe control panel 370). The user may be identified and granted access to the safe 300 by entering a username and/or password, biometrics, remote authorization (e.g., via the communication network or cloud 50), or some other appropriate security access measure. The safe 300 may count the currency 10, dispense the currency 10 into the container 400 within the inner chamber 330, seal the container 400, optionally communicate information (e.g., a currency amount held by the container 400 and withdrawn from the safe, a date-timestamp of the container ejection, etc.) to the communication network or cloud 50 for receipt by the second location 30 (or another party, such as a business owner) and then eject or allow retrieval of the sealed container 400 from the inner chamber 330 of the safe 300. By eliminating a human handling element to the safe withdrawal, the process reduces the chances of human counting errors, mishandling, and theft. The safe 300 can eject the container 400 to the user or some other transportation service, such as directly into a delivery service container (e.g., postal drop box).

In some implementations, the method includes transporting 212 the container 400 from the first location 20, the location of the safe 300, to the second location 30, such as the financial institution. Since the container 400 holds the currency 10 in a tamper-evident manner, commercial delivery services (e.g., courier, postal, etc.) may be used. In some examples, information storage device 410 on the container 400 includes information identifiable by a commercial delivery service, such as the tracking identifier 406b. A commercial delivery service can scan the container 400 and track its movement from the first location 20 to the second location 30.

The method may also include receiving 214 the sealed container 400 in a secure deposit system 60 (FIG. 1) at the second location 30. The secure deposit system 60 may be another safe 300, a deposit box, a bank attendant or some other secure deposit means. The secure deposit system 60 may include a container reader 62 that reads the information stored on the information storage device 410 associated with the container 400. For example, the container reader 62 can be a barcode scanner and/or RF ID reader. The method may include communicating 216 information associated with the received sealed container 400 to the remote computing device 52 or another computing device or storage. For example, after reading the information, the container reader 62 can communicate the information to the financial storage 34.

Referring to FIGS. 1-4B, the method can provide a closed-loop process for tracking currency 10. For example, a merchant 22 can store currency 10 in a secure cash-counting safe 300 at the first location 10, a business location. When the merchant 22 decides to make a bank deposit, the merchant 22 can remove or cause the safe 300 to eject a sealed container 400 that holds the currency in a tamper-evident manner. The container 400 is filled and sealed by the safe 300 before ejection or release of the container 400 from the safe 300. When the container 400 is removed or ejected from the safe 300, the safe 300 may communicate a withdrawal signal (e.g., via the network 50) to the remote computing device 52 (e.g., a remote data center and/or the second location 30), which can update the financial storage 34 (e.g., a database or cloud storage) accordingly. The withdrawal signal may include information such as an origination identifier (e.g., store number), a date-time stamp of the withdrawal, a container identifier, an currency amount of the withdrawal, operator identifier, and any other suitable information. This information may also be associated with the container 400, for example, by applying a label or information storage device 410 to the container 400. The safe 300 may produce (e.g., print or otherwise supply) the information storage device 410 (e.g., a 2D or 3D barcode), which can be applied to the container 400 by the safe 300 or the merchant 22. Rather than being applied to the container 400, the information storage device 410 may accompany the container 400 separately.

The merchant 22 may personally transport the container 400 to the second location 30 (e.g., the financial institution) or use a courier. The tamper evident container 400 and associated information storage device 410 allows tracking and documentation of the chain-of-custody. For example, every change in custody can be tracked and communicated to the first and/or second locations 10, 30 (e.g., the merchant and/or the financial institution). Upon reaching the second location 30, in this case the financial institution, the merchant 22 or courier can bring the container 400 to a bank teller 32 or deposit the container 400 in the secure deposit system 60 (e.g., a kiosk) at the second location 30. The secure deposit system 60 can be configured to read the information storage device 410 associated with the container 400. Similarly, the bank teller 32 can user a reader that reads (or scans) the information storage device 410 (e.g., having machine readable data).

Upon receipt and reading of the information storage device 410, the second location 30 can update the financial storage 34 and credit the merchant 22 with the deposit value in either a provisional credit (subject to verification) or an undisputed deposit. The financial institution 30 can then provide posting credit to the merchant 22 without having to open and count the contents of the container 400. This removes a sense of immediacy to have a bank teller 32 count the currency 10 upon receiving the container 400. Moreover, the financial institution 30 has more options on how to process the container 400. For example, the financial institution 30 may open and verify the contents of the container 400 after business hours, in a secure vault, or even off-site at a processing center. Since the container 400 was filled and sealed by a secure safe 300, without human intervention, transported in a tamper-evident manner, and received at the financial institution 30 with associated data of its contents (e.g., an information storage device 410 or an identification number associated with data transmitted to the financial institution 30 upon withdrawal from the safe 300), the financial institution 30 can rely on the secure currency transportation process for having received a correct un-tampered amount of currency from the merchant 22.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Implementations of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

Implementations of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described is this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the invention or of what may be claimed, but rather as descriptions of features specific to particular implementations of the invention. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multi-tasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

A number of implementations have been described. Nevertheless, it will be understood that various modifications may be made without departing from the spirit and scope of the disclosure. Accordingly, other implementations are within the scope of the following claims.

What is claimed is:

1. A method of handling currency, the method comprising:
receiving currency into a safe at a first location, the safe configured to count and store currency;
receiving a withdrawal request for an amount of currency stored in the safe, in response to the withdrawal request, the safe:
depositing the requested amount of currency into a container,
associating information with the container,
sealing the container, and
after sealing the container, allowing retrieval of the container;
retrieving the sealed container;
transporting the sealed container to a second location; and
receiving the sealed container in a secure deposit system at the second location.

2. The method of claim 1, further comprising communicating at least some of the information associated with the container to at least one of a computing device and a storage device of the second location.

3. The method of claim 2, further comprising communicating the information electronically over a communication network.

4. The method of claim 2, further comprising communicating the information to a cloud computing device.

5. The method of claim 1, wherein the information comprises at least one of an origination location identifier, a destination location identifier, a currency amount, a date stamp, a time stamp, an operator identifier, a transporter identifier, a container identifier, and a merchant identifier.

6. The method of claim 1, further comprising reading the information associated with the container upon receiving the container in the secure deposit system at the second location.

7. The method of claim 1, further comprising storing the information on an information storage device.

8. The method of claim 7, wherein the information storage device comprises at least one of a barcode and a radio frequency identification device.

9. The method of claim 7, further comprising attaching the information storage device to the container.

10. The method of claim 7, further comprising reading the information storage device upon receiving the container in the secure deposit system at the second location.

11. The method of claim 10, wherein the secure deposit system comprises a deposit receiver having a container reader operable to read the information storage device.

12. The method of claim 1, wherein the container comprises a tamper evident container.

13. The method of claim 1, further comprising depositing the requested amount of currency into the container inside the safe.

14. The method of claim 1, further comprising causing the safe to provide a count of the currency deposited in the container.

15. The method of claim 1, further comprising tracking a chain of custody of the container while in transport between the first location and the second location.

16. A currency handling system comprising:
a safe at a first location, the safe:
receiving currency;
counting and storing the currency; and
upon receiving a withdrawal request for an amount of currency stored in the safe, the safe:
depositing the requested amount of currency into a tamper evident container,
associating information with the container,
sealing the container, and
after sealing the container, allowing retrieval of the container; and
a secure deposit system at a second location, the secure deposit system configured to receive the sealed container.

17. The currency handling system of claim 16, further comprising a communicator communicating at least some of the information associated with the container to at least one of a computing device and a storage device of the second location.

18. The currency handling system of claim 17, wherein the communicator communicates the information electronically over a communication network.

19. The currency handling system of claim 17, wherein the communicator communicates the information electronically to a cloud computing device.

20. The currency handling system of claim 17, wherein the communicator comprises a controller of the safe.

21. The currency handling system of claim 20, wherein the safe controller communicates at least some of the information associated with the container to at least one of a computing device and a storage device of the second location upon allowing retrieval of the container.

22. The currency handling system of claim 16, wherein the information comprises at least one of an origination location identifier, a destination location identifier, a currency amount, a date stamp, a time stamp, an operator identifier, a transporter identifier, a container identifier, and a merchant identifier.

23. The currency handling system of claim 16, wherein the secure deposit system reads the information associated with the container.

24. The currency handling system of claim 16, wherein the safe stores the information on an information storage device.

25. The currency handling system of claim 24, wherein the information storage device comprises at least one of a barcode and a radio frequency identification device.

26. The currency handling system of claim 24, wherein the safe attaches the information storage device to the container.

27. The currency handling system of claim 24, wherein the secure deposit system comprises container reader operable to read the information storage device.

28. The currency handling system of claim 24, wherein the information storage device maintains a chain of custody log of the container while in transport between the first location and the second location.

29. The currency handling system of claim 16, wherein the safe deposits the requested amount of currency into the container while housed securely inside the safe.

30. The currency handling system of claim 16, wherein the container comprises a bag having multiple layers of polyethylene film.

31. A currency handling system comprising:
a means at a first location for:
receiving currency;
counting and storing the currency; and
upon receiving a withdrawal request for an amount of stored currency:
depositing the requested amount of currency into a means for transporting the currency in a tamper evident manner,
associating information with the means for transporting the currency,
sealing the means for transporting the currency, and
after sealing the means for transporting the currency, allowing retrieval of the means for transporting the currency; and
a means at a second location for receiving the sealed means for transporting the currency.

32. The currency handling system of claim 31, further comprising a means for communicating at least some of the information associated with the means for transporting the currency to at least one of a computing device and a storage device of the second location.

33. The currency handling system of claim 32, wherein the means for communicating communicates the information electronically over a communication network.

34. The currency handling system of claim 32, wherein the means for communicating communicates the information electronically to a cloud computing device.

35. The currency handling system of claim 31, wherein the information comprises at least one of an origination location identifier, a destination location identifier, a currency amount, a date stamp, a time stamp, an operator identifier, a transporter identifier, a container identifier, and a merchant identifier.

36. The currency handling system of claim 31, further comprising a means for reading the information associated with the container after receipt at the second location.

37. The currency handling system of claim 31, further comprising a means for maintaining a chain of custody log of the means for transporting the currency while in transport between the first location and the second location.
